(19) United States
(12) Patent Application Publication
(10) Pub. No.: US 2004/0118634 A1
(43) Pub. Date: Jun. 24, 2004

(54) Apparatus for refuge from high building and method for refuge thereof

(76) Inventor: Teruhisa Tamamori, Shiga-Pref. (JP)

Correspondence Address: BACON & THOMAS, PLLC, 625 SLATERS LANE, FOURTH FLOOR, ALEXANDRIA, VA, 22314

(21) Appl. No.: 10/414,471

(22) Filed: Apr. 16, 2003

(30) Foreign Application Priority Data
Dec. 19, 2002 (JP) JP2002-368056

(51) Int. Cl. A62B 1/06

(52) U.S. Cl. 182/71

(57) ABSTRACT

The present invention provides an apparatus for refuge from high building capable of being mounted on a rope and facilitating the use for refugee as well as cost inexpensive, and its method for refuge.

The implementation method thereof is of the structure of the apparatus for refuge from high building, comprising a rope 2, the length of which is at least three times of height L from the ceiling 8 of the floor to be given refuge to the refuge place (ground 1), at least one end of the rope being arranged a connecting device 4 for fixation of the rope; a human body retainer 20, for holding a human body, which has a ring 10 for allowing the rope 2 to be threaded through; and a connecting base 6 and a supporting base 7, fixed on the ceiling 8. With such a structure, the apparatus for refuge from high building and method for refuge thereof can be achieved.

### BACKGROUND OF THE INVENTION

1. Field of the Invention

The present invention relates to an apparatus for refuge and its method, which can be quickly and easily utilized at the time of high building having disaster (for example, fire).

2. Description of Related Art

When occurring the disaster, especially for the fire, the means for escaping from the high floor of the building usually employ a refuge method of security ladders or refuge bags. However, depending on the situation of the disaster, it is possible to happen a case of not approaching a site where the refuge apparatus is arranged. Moreover, it needs to take account of the cost for provide apparatus for refuge at a number of places in advance. Further, in terms of the refuge bag, it is impossible for use if there is no assistance from other people.

There are several related arts for the refuge tools using ropes, which relate to a structure of placing a refuge tool on a rope to allow the refugee operating a brake control to adjust the descending speed. However, though the refugees are possible to operate the brake control by themselves, they might be too scared to release the brake. Also, there exists hesitation and difficulty for placing the refuge tool on the rope.

### SUMMARY OF THE INVENTION

In view of the above problem, the object of the present invention is to provide an apparatus for refuge from high building and method for refuge thereof, which has a simple structure and can be quickly and easily utilized by a refugee.

For achieving the object of the invention, the inventor discloses an apparatus for refuge from high building capable of being simply mounted on a rope and facilitating the use for refugee, as well as cost inexpensive relatively, even if the apparatus is provided on a number of places, and also disclose a method for refuge thereof.

According to one aspect of the present invention, an apparatus for refuge from high building is provided, comprising a rope, a length of which is at least three times of a height from a ceiling or fittings of a floor to be given refuge to a refuge place, at least one end of the rope being arranged a connecting device for fixation of the rope; a human body retainer, for holding a human body, which has a ring for allowing the rope to be threaded through; a connecting base, being fixed on the ceiling or fittings of the floor to be given refuge, and connecting with the connecting device arranged on the at least one end of the rope; a supporting base, being fixed on the ceiling or fittings of the floor to be given refuge, through which the rope is threaded.

Further, according to above aspect of the present invention, the ring includes a hook, on top of the hook and root of the hook being arranged a tongue capable of opening/closing, a round shaped cross section of the hook is conical shape protruded toward inside of the ring, and/or a face of the hook which is protruded toward inside of the ring being a wave shaped configuration.

Further, according to above aspect of the present invention, the base includes a hoisting hook, on top of the hoisting hook and root of the hoisting hook being arranged a tongue capable of opening/closing.

Further, according to above aspect of the present invention, the supporting base includes a fixed pulley, the fixed pulley can only be rotated in unidirection.

Furthermore, according to another aspect of the present invention, a method for refuge from high building is provided, by using the apparatus according to any one of claims 1 to 5, said apparatus including a rope, a length of which is at least three times of a height from a ceiling or fittings of a floor to be given refuge to a refuge place, at least one end of the rope being arranged a connecting device for fixation of the rope; a human body retainer, for holding a human body, which has a ring for allowing the rope to be threaded through; a connecting base, being fixed on the ceiling or fittings of the floor to be given refuge, and connecting with the connecting device arranged on the at least one end of the rope; and a supporting base, being fixed on the ceiling or fittings of the floor to be given refuge, through which the rope is threaded, said method comprising the steps of: connecting the connection device of the rope with the connecting base; holding a human body by using the human body retainer; threading the rope through the ring; threading the rope through the supporting based, throwing away the other end of the rope down to a refuge place; and grasping the rope at a position of the rope between the supporting base and the refuge place, and descending simultaneously from a high floor down to the refuge place.

### BRIEF DESCRIPTION OF THE DRAWINGS

The present invention can be more fully understood by reference to the following detailed description and accompanying drawings, in which:

FIG. 1(a) to 1(d) is schematic drawings, showing a whole structure of the apparatus for refuge from high building of one embodiment in accordance with the present invention;

FIG. 2(a) and 2(b) are illustrative drawing, showing a ring arranged at end of a rope of the embodiment in accordance with the present invention;

FIG. 3(a) is a side view, showing a connecting base and a supporting base of the embodiment in accordance with the present invention;

FIG. 3(b) and 3(c) are cross section view, showing a hoisting hook of the connecting base and the supporting base of FIG. 3(a);

FIG. 4(a) is an oblique view, showing a human body retainer of the embodiment in accordance with the present invention;

FIG. 4(b) and 4(c) are cross section views, showing a hook of ring of the human body retainer of FIG. 4(a); and

FIG. 5 is a perspective view, showing a fixed pulley of the apparatus for refuge from high building of the embodiment in accordance with the present invention.

### List of reference numerals

1 ground (refuge place)

2 rope

4 connecting device

6 connecting base

7 supporting base

8 ceiling

10 ring

12,18,34 tongue

14 fixed mount

15 top

16,32 hook

17 root

20 human body retainer

22 waist belt

24 Hip belt

26 connecting rope

28 adjusting member

30 shoulder belt

36 fixed pulley

38 pulley section

40 door means

42 sawtooth

44 pulley support

46 pawl

### DETAILED DESCRIPTION OF THE PREFERRED EMBODIMENT

The following describes an apparatus for refuge from high building and method for refuge thereof according to the present invention, by way of an embodiment with reference to accompanying drawings. However, the present invention will not be limited by the illustrative embodiment.

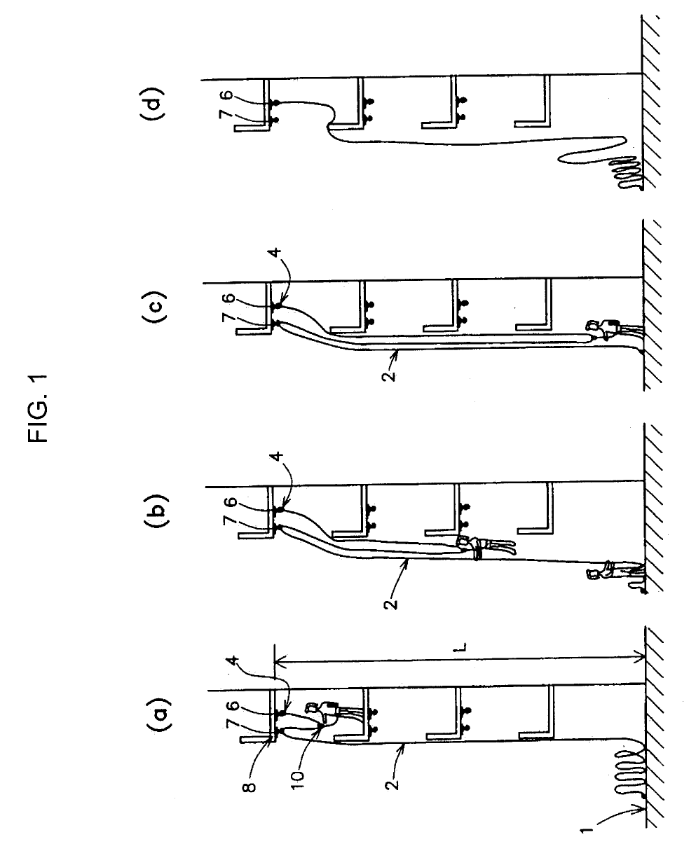

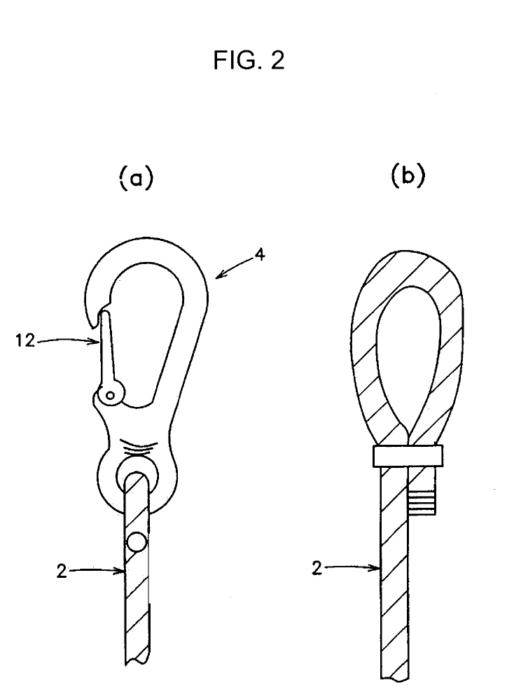

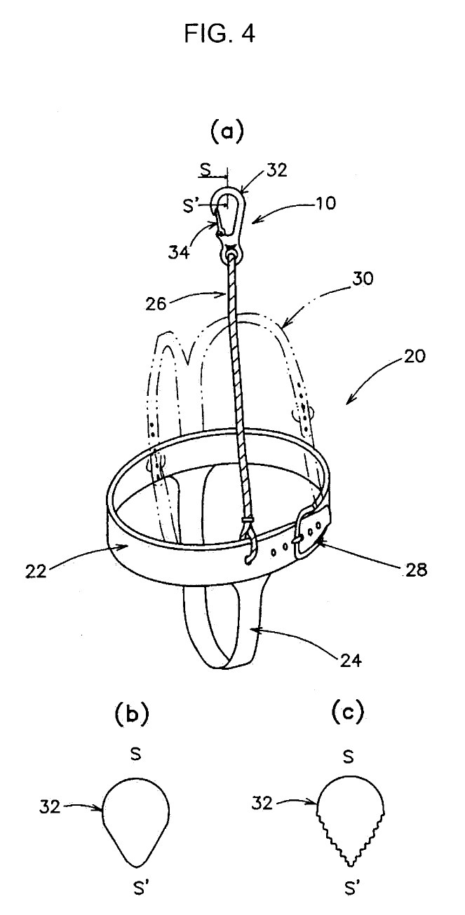

As shown in FIG. 1(a) to FIG. 1(d), which are schematic drawings showing a whole structure of the apparatus for refuge from high building of one embodiment of the invention. The length of rope 2 is at least three times of the height L from a wall, such as ceiling 8 of the floor to be given refuge to ground 1. Also, as shown in FIG. 2(a), at least one end of the rope 2 is arranged a connecting device 4. The connecting device 4 is a “C” configuration. The opening of the connecting device 4 is provided with a tongue 12. Further, as shown in FIG. 4(b), the opening of end of the rope 2 is shaped as an internal ring.

As shown in FIG. 1, on ceiling 8, there are provided a connecting base 6 for connecting with a connecting device 4 located at an end of a rope 2 and a supporting base 7 for the rope 2 to be threaded. The connecting base 6 is connected with a connecting device 4 and the supporting base 7 is threaded through by the rope 2. Though the connecting base 6 and supporting base 7 have different functions, both of them can be put the same configuration in use. As shown in 3(a), the top of the connecting base 6 and the supporting base 7 are arranged a fixed mount 14 toward to the ceiling. The simplest configuration of a hoisting hook 16 arranged on the connecting base 6 and the supporting base 7 is “C” shape which can be easily for connection with the connecting device 4 at the end of the connecting rope 2 and for the rope 2 to be threaded through. Further, a movable tongue 18 can be provided on top 15 of the hoisting hook 16 and foot 17 of the hoisting hook 16 for open/close of the hook 16 to prevent the connecting rope 2 from escape.

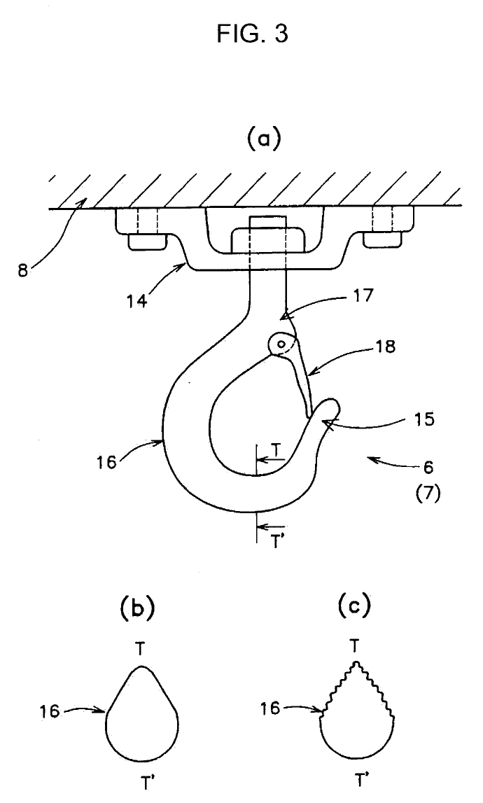

To increase the friction between the supporting base 7 and the rope 2, the configuration of the supporting base 7 is preferably made as a shape of conical protrusion, such as a shape of drop, in a cross-section view on line T-T′, as shown in FIG. 3(b). Further, the surface of the conical protrusion can be made as a wave-shaped configuration to obtain more friction, as shown in FIG. 3(c).

On the other hand, FIG. 4(a) shows an example of a human body retainer 20. The human body retainer 20 includes a waist belt 22 for fastening of waist, a hip belt 24 for connection of front central portion and rear central portion of the waist belt 22 to support the hip of refuge, and a ring 10 for being threaded by the rope 2. The ring 10 is provided at one end of a connecting rope 26 which is connected to the front central portion of the waist belt 22. The refuge may easily wear the human body retainer 20 by putting the foot in between the waist belt 22 and hip belt 24. An adjusting member 28 is provided on the front of the waist belt 22 for adjustment of waist belt 20 so as to be suitable for various kind of body type. Further, as shown in the phantom line of FIG. 4(a), the human body retainer 20 can be provided with a shoulder belt 30 which is wearable and arranged from the rear portion of waist belt 22 to the front portion of waist belt 22 through the shoulders of the refugee. When the refuge is hanged by the rope 2 in the situation of turning upside down, the shoulder belt 30 can prevent the refugee from sliding away. The arranged position for the connecting rope 26 is not restricted to the front central portion of the waist belt 22 and may be arranged on the rear central portion of the waist belt 22.

The ring 10, which is provided on the top of the connecting rope 26 that is connected to the front central portion of the waist belt 22, is provided with a hook 32 for ease of connection with the rope 2. The hook 32 appears “C” shape and may be arranged a tongue 34 on its opening for preventing the rope 2 from escape. Further, the cross section of the ring 10 along line S-S′ can be made as a conical protrusion and/or wave-shaped surface in order to increase the friction between the threaded rope 2 and the ring 10, as shown in FIG. 4(b) and 4(c).

Because the structure of the apparatus for refuge from high building in accordance with the invention is very simple, the refuge may quickly escape from the high building without complicated preparation for refuge.

Additionally, though the above embodiment directs to have a ground for refuge, however, the refuge place is not restricted to the ground but the floors lower than the floor to be given refuge. In such a circumferences it is sufficient for refuge that the length of the rope 2 is indeed at least three times of height from the floor to be given refuge to the refuge place. Besides the lower floor, the root of neighboring building can also be a refuge place.

The following describes the method for refuge by using the above-described apparatus in accordance with the invention, and also illustrates the refuge place of ground in detail. Though the description is simply exemplary by only one example, however, the invention will not be limited in the following steps.

The preparation for refuge is made by firstly connecting the connection device 4 of the rope 2 to the connecting base 6, then using the human body retainer 20 to hold the body and hanging the ring 10 of the human body retainer 20 on the rope 2, threading a portion of the rope 2 which is in between the ring 10 and the other end of the rope 2 through the supporting base 7, and dropping the other end of the rope 2 to the ground 1.

After completion of the preparation, as shown in FIG. 1(b), the refugee grasps the rope 2 at the position between the supporting base 7 and the ground 1 and descends down to the ground 1 by self body weight. The descending speed can be self-adjusted by grasping the rope 2 and adding a force smaller than half of the body weight. The conical protrusion configuration arranged on the supporting base 7 (see T-T′ cross section) and the ring 10 of the human body retainer (see S-S′ cross section) may increase the friction with the rope 2 so as to reduce the necessary adjustment force for the descending speed, as shown in FIG. 3(b) and 4(b). Further, because the above described surface of the conical protrusion configuration is made as wave-shape, this more friction can be obtained to reduce the burden of the refugee, as shown in FIG. 3(c) and 4(c).

Further, during the process for refuge, because the rope 2 falls from the floor to be given refuge to the ground 1 and somebody may assist on the ground 1, the burden of the refuge will be further reduced, as shown in FIG. 1(b). Moreover, by grasping the rope 2 between the ring 10 and the supporting base 7 and the rope 2 between the supporting base 7 and ground 1 simultaneously, or other manner such as, clamping the rope 2 by rope to increase the friction between ropes, can also reduce the burden of the refugee.

When a first refugee comes to ground 1, as shown in FIG. 1(c), the first refugee releases the ring 10 of human body retainer 20 from the rope 2. The second refugee disconnects the rope 2 from the supporting base 7 and drops the disconnected rope 2 to the ground 1. At this time, the situation returns to the initial condition of connecting the connection device 4 to the connecting base 6, as show in FIG. 1(d). Then, the second refugee repeats all the above described operating steps such as wearing the human body retainer 20, and so on, so as to more out quickly.

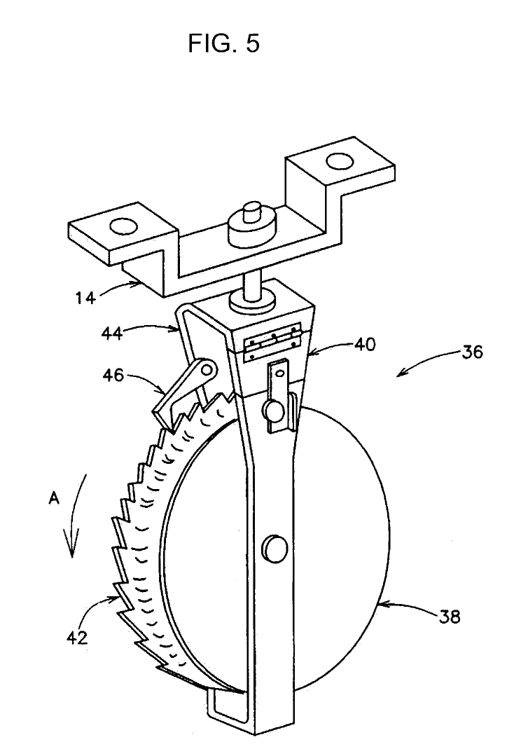

Here, a fixed pulley can be used instead of the supporting base 7. FIG. 5 shows an example for a unidirectionally rotating structure of a fixed pulley 36. The feature of the structure of the fixed pulley 36 is that it can only be rotated in the direction of pulling the rope (direction A). Concretely speaking, the peripheral flange of the pulley section 38 can be designed as a shape of sawtooth 42, wherein the direction of sawtooth is toward to the direction A. In pulley support 44, there is provided with a pawl 46 which can engage to the saw tooth 42. When the pulley section 38 rotates in direction A, the pawl 46 may release the pulley due to match of the sawtooth, however, if the force is applied in reverse direction of direction A, then the pawl 46 can stop the reverse rotation of the pulley section 38.

In general, by using the above method for refuge, if the rope 2 is pulled in reverse direction, the burden for adjusting the descending speed can be reduced because the pulley section 38 can not be reversible such that the friction between the rope 2 and fixed pulley 36 is increased. Further, the wave-shaped surface design of the pulley can also reduce the burden of the refugee. Further, the fixed pulley 36 can be provided with a fixed mount 14 which is the same as that for the connecting base 6. Also, the upper portion of the pulley section 38 can be provided with a door means 40 to allow the rope 2 to be removed.

Above description illustrates the method for refuge from high building by using the apparatus according to the invention. Based on the above-described method, it is possible for quickly and simply implementing the refuge by preparing a plurality of the human body retainer 20 in advance. Additionally, if using a frame box to substitute the human body retainer 20, then it allows several refugees to move away.

On the other hand, the method using the apparatus for refuge from high building in accordance with the invention is not only for refuge from high building to the ground, but also from ground to high building. In short, when at the completion for refuge as shown in FIG. 1(c), the rescue person can wear the human body retainer 20 and pull the rope 2 downwards to raise him up to the floor to be given refuge. As soon as the rescue person arrives that floor, the rescue person can assist the refugees to implement the rescue procedure for facilitation of the refuge.

Therefore, it is preferable to use the fixed pulley 36 instead of the supporting base 7 for facilitation of the rescue person arriving the floor. When employing the fixed pulley 36 and pulling the rope 2 in direction A, the rescue person can raise up smoothly due to less friction caused by the pulley section 38.

Though the above description relates to different modes of the apparatus and method for refuge from high building according to the present invention, the person who is skillful in this technology should recognize that various change, equivalence and modification without departing from the object of the invention must be considered as within the scope and spirit of the invention.

For example, the substitution for the supporting base 7 is to prevent the refugee from releasing too much rope such that the rapid descending conditions occur. It is preferable to use a supporting base or fixed pulley with a powerful tongue control device. It is preferable to use a structure of chain or band for the rope 2.

Moreover, the rope 2 can be connected and threaded through the connecting base 6 of the floor to be given refuge, and saved in a storage box arranged on or in the wall. Further, it is preferred to use a connecting base 6 which is protruded out of the building during use.

Also, the ring 10 of the human body retainer 20 can be instead of a moving pulley. With the moving pulley, the refuge can be smoothly proceeded.

### EFFICACY OF THE INVENTION

The apparatus for refuge from high building of the invention is composed of rope, human body retainer, connecting base, and supporting base. Due to simple structural constituents, it is easy to use by the refugee for quick escape. Particularly, when arranging the human body retainer on the rope, the only thing is to hang the ring of the human body retainer on the rope without complicated preparation for refuge.

By making the cross section of the ring of human body retainer and the hook of the supporting base as the conical protruded and/or wave-shaped configuration. The refugees can adjust the descending speed by a force less than half of their weight for implementation of refuge.

Regarding the connecting base and the supporting base, the place for arrangement is not limited due to their inexpensive costs for the arrangement. Thus, they can be arranged in many places in advance such that they can be found in number of places during the refuge. Particularly, they don't need any external power source and can be used during shutdown of the electricity.

Moreover, concerning the fixed pulley according to the invention, the more friction can be obtained due to its structure of unidirectional rotation. On the other hand, the rescuer person can raise up smoothly when using it to go on floors.

In general, according to the method of the invention, the refugee can self-adjust the descending speed and also can quickly process the refuge. Moreover, during the refuge, the rope has already reached to the ground, other people on the ground can assist the refugee to escape. Additionally, the rescue person can easily raise up to the floor to be given the refuge to assist the operation for refuge. Therefore, the operation for refuge can be quickly and effectively proceeded.

What is claimed is:

1. An apparatus for refuge from high building, comprising:
a rope, a length of which is at least three times of a height from a ceiling or fittings of a floor to be given refuge to a refuge place, at least one end of the rope being arranged a connecting device for fixation of the rope;
a human body retainer, for holding a human body, which has a ring for allowing the rope to be threaded through;
a connecting base, being fixed on the ceiling or fittings of the floor to be given refuge, and connecting with the connecting device arranged on the at least one end of the rope; and
a supporting base, being fixed on the ceiling or fittings of the floor to be given refuge, through which the rope is threaded.

2. The apparatus according to claim 1, wherein said ring includes a hook, on top of the hook and root of the hook being arranged a tongue capable of opening/closing, a round shaped cross section of the hook is conical shape protruded toward inside of the ring, and/or a face of the hook which is protruded toward inside of the ring being a wave-shaped configuration.

3. The apparatus according to claim 1 or 2, wherein said supporting base includes a hoisting hook, on top of the hoisting hook and root of the hoisting hook being arranged a tongue capable of opening/closing.

4. The apparatus according to claim 1, wherein said supporting base includes a fixed pulley.

5. The apparatus according to claim 4, wherein said fixed pulley is rotated in unidirection.

6. A method for refuge from high building, by using the apparatus according to any one of claims 1 to 5, said apparatus including a rope, a length of which is at least three times of a height from a ceiling or fittings of a floor to be given refuge to a refuge place, at least one end of the rope being arranged a connecting device for fixation of the rope; a human body retainer, for holding a human body, which has a ring for allowing the rope to be threaded through; a connecting base, being fixed on the ceiling or fittings of the floor to be given refuge, and connecting with the connecting device arranged on the at least one end of the rope; and a supporting base, being fixed on the ceiling or fittings of the floor to be given refuge, through which the rope is threaded, said method comprising the steps of:
connecting the connection device of the rope with the connecting base,
holding a human body by using the human body retainer, threading the rope through the ring;
threading the rope through the supporting based;
throwing away the other end of the rope down to a refuge place; and
grasping the rope at a position of the rope between the supporting base and the refuge place, and descending simultaneously from a high floor down to the refuge place.
